(19) United States
(12) Patent Application Publication
(10) Pub. No.: US 2025/0359557 A1
(43) Pub. Date: Nov. 27, 2025

(54) HOUSEHOLD FOOD PROCESSING DEVICE

(71) Applicant: WHIRLPOOL CORPORATION, Benton Harbor, MI (US)

(72) Inventors: JACOB W. EVERIDGE, SAINT JOSEPH, MI (US); BENJAMIN EDINGER, GRAND HAVEN, MI (US); ZACHARY GRAVES, GRAND HAVEN, MI (US); JOSEPH SNYDER, BENTON HARBOR, MI (US)

(21) Appl. No.: 18/673,600

(22) Filed: May 24, 2024

(51) Int. Cl. A21C 3/02

(52) U.S. Cl. CPC A21C 3/027

(57) ABSTRACT

A household food processing device includes a housing, a pair of rollers having a first roller with a stationary axle and a second roller with a pivotable axle. Further, the household food processing device includes an indexing mechanism configured for adjusting a dough thickness, and a clutch mechanism configured to disengage at least one of the first roller or the second roller.

### TECHNICAL FIELD

The description generally relates to a household food processing device, in particular a household food processing device for processing sheets of dough.

### BACKGROUND

Household food processing devices, such as dough rollers, typically have rotating rollers for processing food items such as dough.

### BRIEF DESCRIPTION

The disclosure relates to a household food processing device, comprising: a housing; and a pair of rollers comprising a first roller that is rotatable about a stationary axis and a second roller rotatable about a second axis, wherein the pair of rollers defines a gap therebetween and a size of the gap defines a dough thickness, and wherein the size of the gap is adjustable by moving the second axis of the second roller.

### BRIEF DESCRIPTION OF THE DRAWINGS

In the drawings:

FIG. 1 is a side perspective view of a stand mixer with the household food processing device.

FIG. 2 is a perspective view of a driving side of the household food processing device.

FIG. 3 is an exploded view of the household food processing device.

FIG. 4 is a side view of an adjustment side of the household food processing device in a first position.

FIG. 5 is a side view of the adjustment side of the household food processing device in a second position.

FIG. 6 is a side view of the driving side of the household food processing device in the first position.

FIG. 7 is a side view of the driving side of the household food processing device in the second position.

### DETAILED DESCRIPTION

Traditional household food processing devices such as food processors, dough rollers, and pasta makers allow the household food processing device to roll, cut, stir, or otherwise process food items. In some instances, it may be desirable for the household food processing device to have an automatic feature in which rollers, blades, or stirrers can be stopped without manual powering off of the household food processing device or a device providing mechanical input to the household food processing device.

Additionally, it may be desirable for the household food processing device to have a user interface in which the thickness or size of the food processed by the household food processing device can be changed or tailored to a user's preferences or needs.

Features, advantages, and aspects of the present disclosure are set forth or apparent from a consideration of the following detailed description, drawings, and claims. Moreover, the following detailed description is exemplary and intended to provide explanation without limiting the scope of the disclosure as claimed.

As used herein, the terms “first,” “second,” or the like can be used interchangeably to distinguish one component from another and are not intended to signify location or importance of the individual components. In addition, the singular forms “a,” “an,” and “the” include plural references unless the context clearly dictates otherwise.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., top, bottom, vertical, horizontal, etc.) are only used for identification purposes to aid the reader's understanding of the present disclosure, and do not create limitations, particularly as to the position, orientation, or use of aspects of the disclosure described herein. Connection references (e.g., attached, coupled, fastened, and connected) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

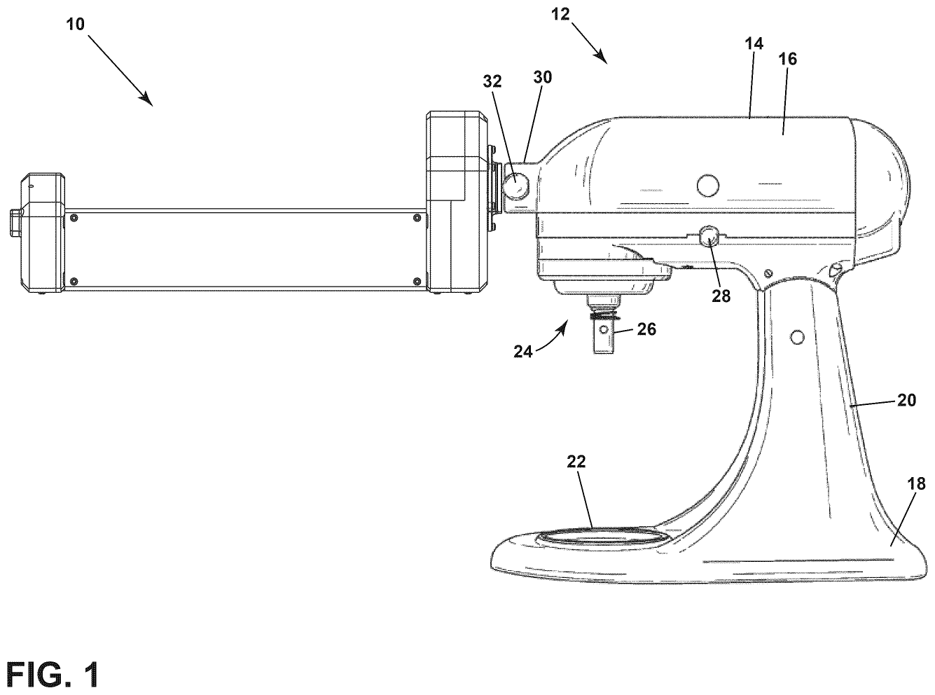

FIG. 1 shows a household food processing device 10 as used with a countertop stand mixer 12. The stand mixer 12 includes an articulating upper arm 14 and an external housing 16 which houses a motor therein. The stand mixer 12 further includes a base portion 18 which is weighted to support the leverage realized on the stand mixer 12 when the household food processing device 10 is coupled thereto. The base portion 18 includes a support arm 20 and a bowl receiving landing 22. A mixing assembly 24 includes a mixer shaft coupling 26. The stand mixer 12 further includes an arm locking mechanism 28 which is adapted to lock the articulating upper arm 14 in an in-use or operational position shown in FIG. 1.

The stand mixer 12 includes a drive outlet attachment hub 30 disposed on a front-most portion of the articulating upper arm 14. The drive outlet attachment hub 30 includes a locking mechanism 32 adapted to lock attachments such as the household food processing device 10 in place as mounted on the stand mixer 12. The external housing 16 houses a drive motor which is adapted to power the mixer shaft coupling 26 as well as a rotating drive outlet disposed within the drive outlet attachment hub 30. In this way, the drive motor of the stand mixer 12 is adapted to power both mixing and attachment-based processes.

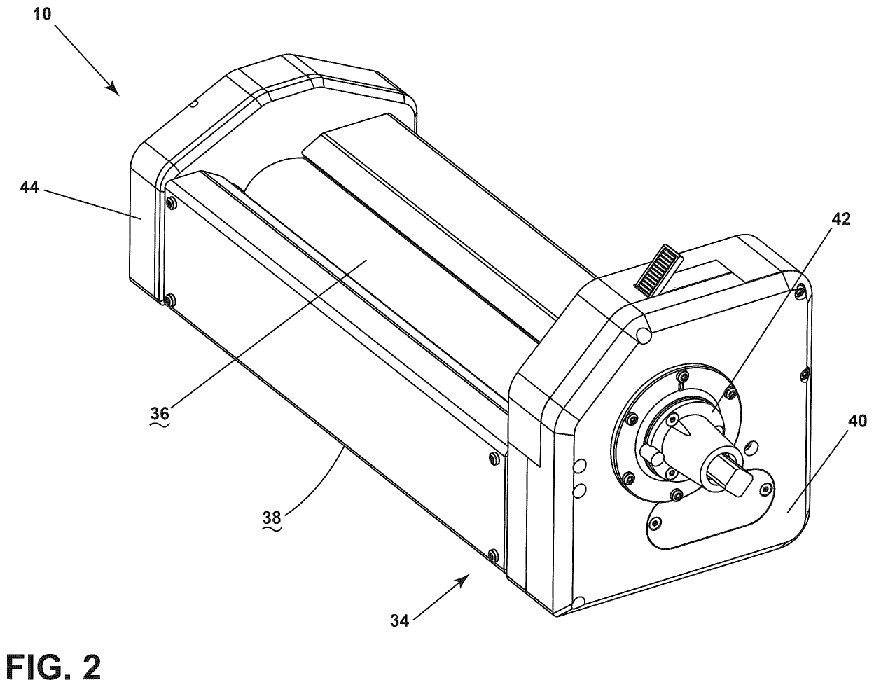

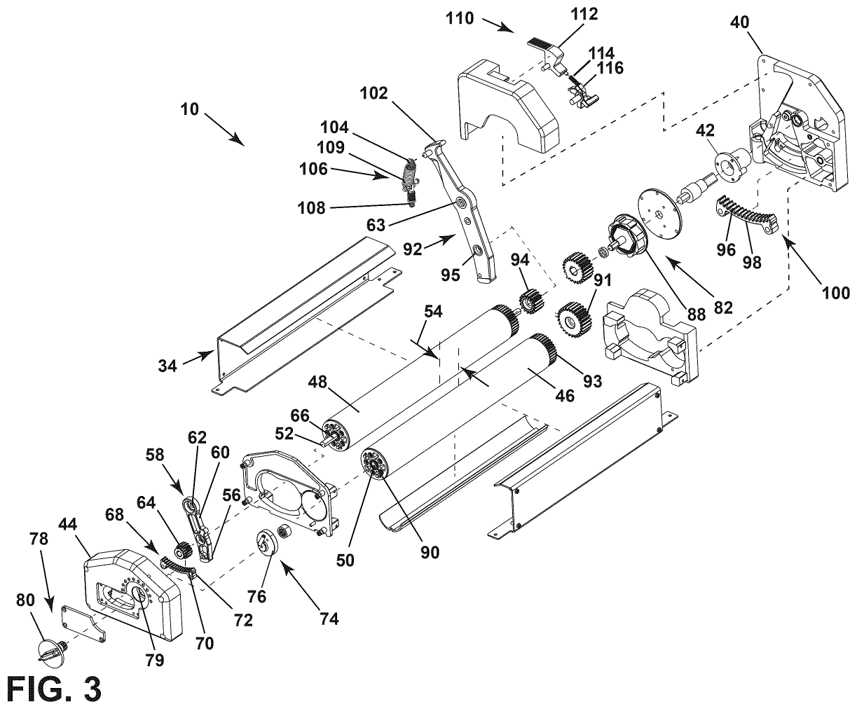

FIG. 2 shows a perspective view of the household food processing device 10. The household processing device is shown in the form of a dough roller or a household food processing device for processing sheets of dough. It will be understood that aspects of the invention could be utilized in alternative household food processing devices. The household food processing device 10 as illustrated includes a device housing 34. A top portion of the device housing 34 is provided with a rolling inlet 36 and a bottom portion of the device housing 34 is provided with a rolling outlet 38. The rolling inlet 36 allows a dough to enter and the rolling outlet 38 allows a processed dough sheet to exit. A driving side 40 of the device housing 34 includes an input hub 42. The input hub 42 is configured for attachment with the drive outlet attachment hub 30 (FIG. 1). That is, the input hub 42 is configured to support the household food processing device 10. An adjustment side 44 of the device housing 34 is located opposite of the driving side 40. The adjustment side 44 includes a user interface discussed further in FIG. 3.

FIG. 3 is an exploded view of the household food processing device 10. The household food processing device 10 includes a pair of rollers disposed inside the device housing 34. The pair of rollers includes a first roller 46 and a second roller 48. By way of non-limiting example, the first roller 46 and the second roller 48 can be substantially cylindrical. The first roller 46 is parallel to the second roller 48. The first roller 46 is rotatable about a stationary axis 50. Further, an axle 90 of the first roller 46 is fixedly coupled in the device housing 34. The second roller 48 is rotatable about a second axis 52. The first roller 46 and the second roller 48 define a gap 54 therebetween, and a size of the gap 54 defines a dough thickness. The size of the gap 54 is adjustable by moving the second axis 52 of the second roller 48 away from the first roller 46 to enlarge the gap 54 or towards the first roller 46 to reduce the gap 54.

A first pivot arm 58 extends between a first end 56 and a second end 60. The first end 56 of the first pivot arm 58 is coupled to the axle 66 of the second roller 48. The second end 60 of the first pivot arm 58 defines a pivot point 62 about which the first pivot arm 58 and the second roller 48 pivot.

A pinion gear 64 is operably coupled to the second roller 48. That is, the pinion gear 64 is pivotably mounted to an axle 66 of the second roller 48. A second gear 68 configured to operably couple and mesh with the pinion gear 64 is included within the device housing 34. When actuated the pinion gear 64 is moveable along a body 70 of the second gear 68. This moves the axle 66 with the second axis 52 of the second roller 48 and in turn changes the size of the gap 54. In the non-limiting example illustrated, the second gear 68 is a rack gear 72. However, it is contemplated that the second gear 68 can be any suitable type of gear including by way of further non-limiting example a worm gear.

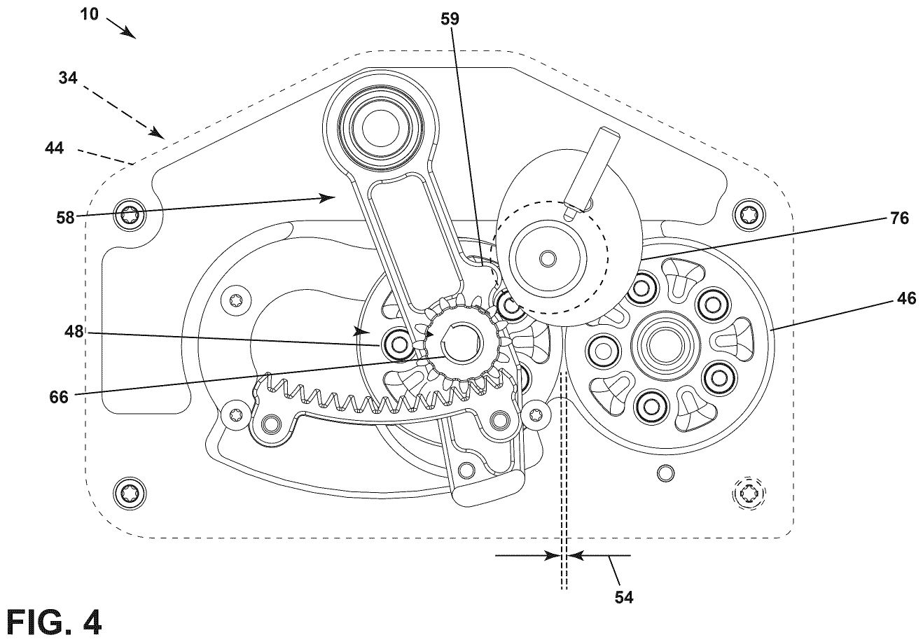

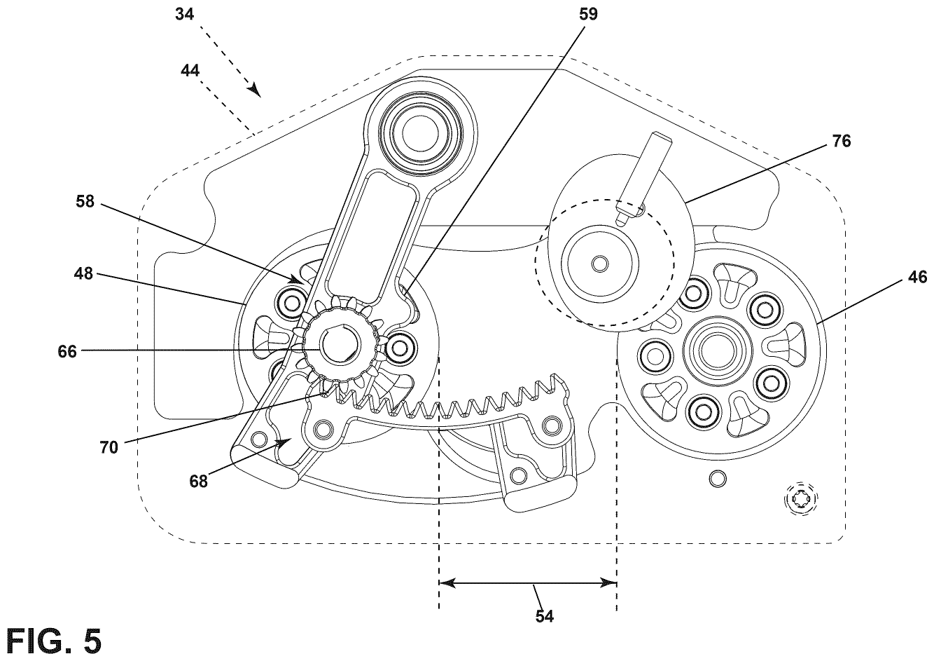

An indexing mechanism 74 is operably coupled to the first end 56 of the first pivot arm 58. The first end 56 of the first pivot arm 58 is moveable between a first position (FIG. 4) defining a gap having a first size and a second position (FIG. 5) defining a gap having a second size. Further, the indexing mechanism 74 defines a number of intermediate positions having respective intermediate gap sizes. In the non-limiting example shown, the indexing mechanism 74 is a cam 76. The cam 76 defines a minimum size of the gap 54.

A user interface 78 is configured to provide input to the indexing mechanism 74. In the non-limiting example shown, the user interface 78 is a dial 80. The dial 80 is configured to provide mechanical input to the indexing mechanism 74. The dial 80 rotates about a rotational point 79 on the device housing 34. It is contemplated in a non-limiting example, that the dial 80 can be located anywhere on the device housing 34. Further, the dial 80 provides rotational input to the cam 76. That is, the cam 76 can be rotated to define a minimum size of the gap 54, by limiting the range of motion of the first pivot arm 58 with the axle 66 of the second roller 48 when the first pivot arm 58 is in the first position (FIG. 4). In a non-limiting example, the cam 76 can contact the first pivot arm 58 to define the first position (FIG. 4). The cam 76 with the dial 80 are spaced from the first pivot arm 58 such that the cam 76 can contact the first pivot arm 58 in the first position (FIG. 4), but not contact the first pivot arm 58 in the second position (FIG. 5). In another non-limiting example, the user interface 78 can include a lever with a pivotable cam.

A planetary gear assembly 82 is operatively coupled to the input hub 42. The input hub 42 provides mechanical input to the planetary gear assembly 82 from the stand mixer 12 (FIG. 1). In a non-limiting example, the planetary gear assembly 82 can provide mechanical input to the first roller 46 through a first gear 91 and a second driven gear 93 operably coupled to the first gear 91. The first gear 91 is coupled to the planetary gear assembly 82. The axle 90 of the first roller 46 includes the second driven gear 93. That is, the second driven gear 93 is mounted to the axle 90 such that the second driven gear 93 rotates about the axle 90 and the stationary axis 50. The second driven gear 93 is coupled to the first roller 46 and provides rotational input to the first roller 46. That is, the second driven gear 93 is configured to receive mechanical input from the first gear 91 and in turn rotates the first roller 46. In another non-limiting example, the planetary gear assembly 82 can provide mechanical input to the first roller 46 through a belt.

A second pivot arm 92 is located on the driving side 40 and operably coupled to a receiving portion 95 of the second roller 48. More specifically, the axle 66 of the second roller 48 couples the first pivot arm 58 to the second pivot arm 92 such that the second roller 48 extends between the first pivot arm 58 and the second pivot arm 92. A pinion gear 94 is pivotably mounted to the axle 66 of the second roller 48. The pinion gear 94 is moveable along a body 96 of a second gear 98 to mirror the mechanism on the adjustment side 44 and move the opposite side of the second roller 48 to change the size of the gap 54 and keep the gap 54 substantially even. That is, the first pivot arm 58 and the second pivot arm 92 pivot synchronously and carry the axle 66 with the second roller 48. In the non-limiting example illustrated, the second gear 98 is a rack gear 100. The second pivot arm 92 includes a pivot point 63 about which the second pivot arm 92 and the second roller 48 pivot.

A first end 104 of a biasing mechanism 106 couples to a portion of the second roller 48 or a component coupled to the second roller 48. In the non-limiting example shown, the component is the second pivot arm 92. One difference from the adjustment side 44 is that the second pivot arm 92 extends past the pivot point 63 to a distal end 102. That is, the distal end 102 of the second pivot arm 92 is coupled to a first end 104 of a biasing mechanism 106. A second end 108 of the biasing mechanism 106 couples to the device housing 34. In the non-limiting example illustrated, the biasing mechanism 106 is a spring 109 although it will be understood that any suitable biasing mechanism can be utilized. The spring 109 provides a biasing force to the second roller 48 such that force within a predetermined range is provided to the second roller 48 regardless of size of the gap 54.

The household food processing device 10 further includes a clutch mechanism 110 configured to disengage at least one of the first roller 46 or the second roller 48 when a foreign object is placed in between the first roller 46 and the second roller 48. A switch 112, a biasing member 114, and a pawl 116 are included in the clutch mechanism 110. The pawl 116 is selectively coupled to the outer ring 88 of the planetary gear assembly 82. The switch 112 is coupled to the pawl 116 by the biasing member 114. In a non-limiting example, the biasing member 114 can be a compression spring, though that need not be the case, the biasing member can be any suitable type of biasing member.

FIG. 4 illustrates a side view of the adjustment side 44 of the household food processing device 10 configured in the first position, with the device housing 34 shown in phantom so parts and assemblies within the device housing 34 can be better illustrated for clarity. A predetermined minimum size of the gap 54 defines the first position. In the first position, the first pivot arm 58 with the axle 66 of the second roller 48 is pivoted towards the first roller 46. The cam 76 contacts the first pivot arm 58 at a stop portion 59, preventing the first pivot arm 58 with the axle 66 carrying the second roller 48 from moving closer to the first roller 46.

FIG. 5 illustrates a side view of the adjustment side 44 of the household food processing device 10 configured in a second position, with the device housing 34 shown in phantom for clarity. A predetermined maximum size of the gap 54 defines the second position. In the second position, the first pivot arm 58 with the axle 66 of the second roller 48 is pivoted to an end of the body 70 of the second gear 68 via insertion of a large piece of dough or insertion of a foreign object. The cam 76 does not contact the first pivot arm 58 or the stop portion 59.

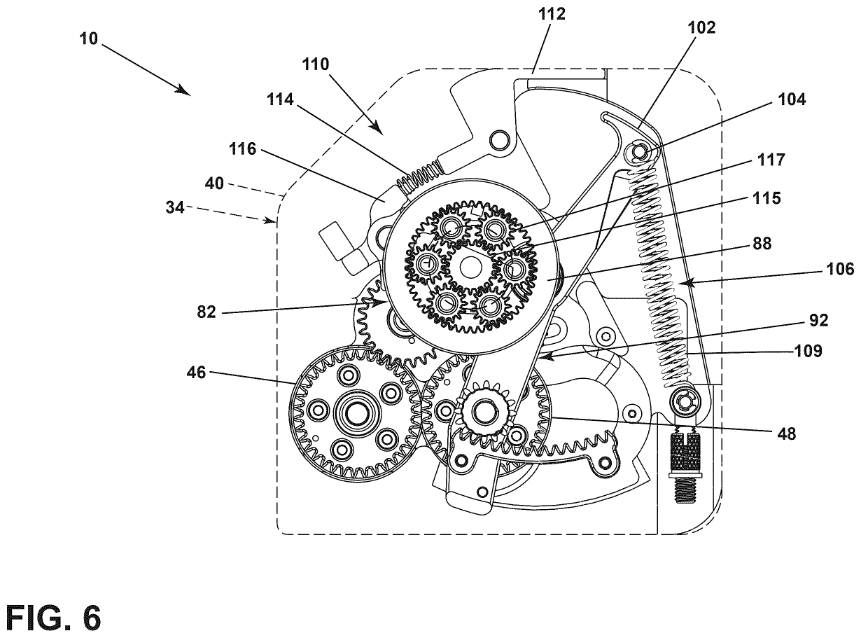

FIG. 6 illustrates a side view of the driving side 40 of the household food processing device 10 when the second roller 48 is in the first position (FIG. 4). In the non-limiting example illustrated, the clutch mechanism 110 is in the first position. An input gear 115, one or more planet gears 117, and the outer ring 88 make up the planetary gear assembly 82. The pawl 116 is coupled to the outer ring 88, fixing the outer ring 88 in a stationary position. In a non-limiting example, a plurality of protrusions or hooks (not shown) are located on an outer peripheral edge of the outer ring 88. The pawl 116 couples to one or more of the protrusions or hooks on the outer ring 88 to fix the outer ring 88. The switch 112 is in an un-extended position or flush with the driving side 40 of device housing 34. The biasing member 114 holds the pawl 116 onto the outer ring 88. The clutch mechanism 110 is selectively coupled with the planetary gear assembly 82. That is, the pawl 116 selectively couples to the outer ring 88, and further couples the biasing member 114 and the switch 112 to the planetary gear assembly 82. The switch 112 is pivotably coupled to the driving side 40 of the device housing 34. It is contemplated in a non-limiting example, that the switch 112 is located on a top portion of the driving side 40 of the device housing 34, however that need not be the case.

The biasing mechanism 106 is un-extended. The first end 104 of the spring 109 provides a biasing force to the distal end 102 of the second pivot arm 92. That is, force within a predetermined range is provided to the second roller 48 via the biasing mechanism 106 and the second pivot arm 92.

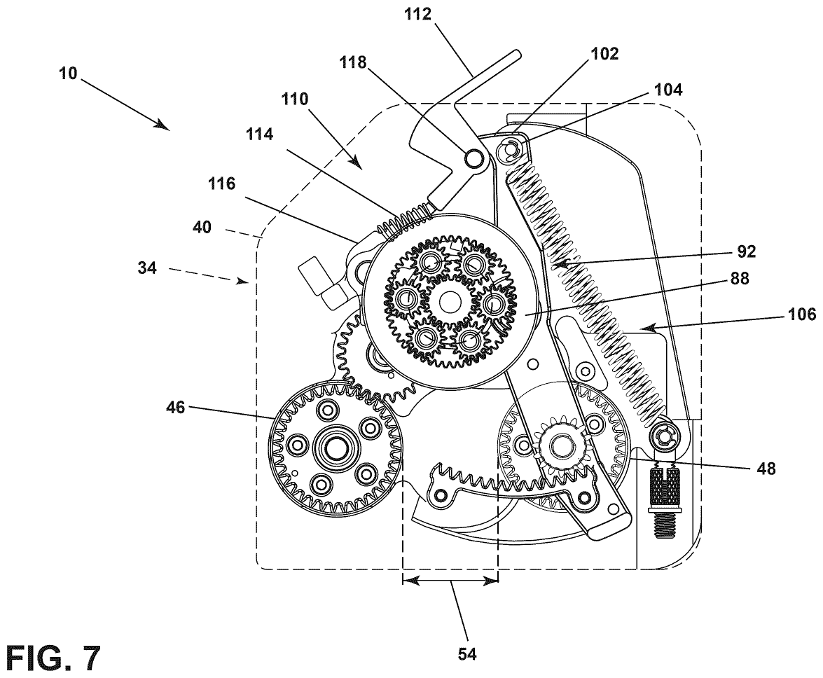

FIG. 7 illustrates a side view of the driving side 40 of the household food processing device 10 when the second roller 48 is in the second position (FIG. 5). In the second position, the first roller 46 and the second roller 48 are at a predetermined maximum size of the gap 54. The switch 112 is rotatable about a switch pivot point 118. The switch 112 is coupled to or supported at the switch pivot point 118 by the housing 34. The distal end 102 is in contact with the switch 112. In the non-limiting example shown, the switch 112 is in an extended position, wherein the switch 112 is not flush with the device housing 34. The biasing member 114 is compressed, and the pawl 116 is uncoupled from the outer ring 88.

The biasing mechanism 106 is extended. The first end 104 of the spring 109 provides a biasing force to the distal end 102 of the second pivot arm 92. That is, force within a predetermined range is provided to the second roller 48 via the biasing mechanism 106 and the second pivot arm 92.

Referring to FIG. 1-FIG. 7 during operation, a user can adjust the minimum dough thickness of household food processing device 10 by rotating the dial 80 of the indexing mechanism 74. The dial 80 pivots the cam 76 which defines the minimum gap size, or the first position (FIG. 3), selected by the user. Once a food item, such as dough, is place into the rolling inlet 36, mechanical input is applied to the input hub 42 from the stand mixer 12. The first roller 46 is rotated by the planetary gear assembly 82. The first roller 46 and the second roller 48 rotate to process the dough. The first pivot arm 58 and the second pivot arm 92 coupled to the axle 66 of the second roller 48 can simultaneously pivot along the body 70 of the second gear 68 (FIG. 4 and FIG. 5) and the body 96 of the second gear 98 (FIG. 6 and FIG. 7) to a position larger than the minimum size of the gap 54. As the dough is processed and becomes more sheet-like, the first pivot arm 58 and the second pivot arm 92 with axle 66 of the second roller 48 begin to pivot towards the first roller 46, reducing the gap 54 to the minimum gap size. It is important to note that the force applied by the second roller 48 to the dough during operation is within a predetermined range, due to the biasing mechanism 106 coupled to the distal end of the second pivot arm 92 and the device housing 34. Once the dough reaches the selected dough thickness, axle 66 of the second roller is at the minimum gap size, or the first position. That is, the cam 76 comes in contact with the first pivot arm 58, stopping the axle 66 of second roller 48 from pivoting closer to the first roller 46.

When the user places the dough as a dough ball or thick piece of dough into the rolling inlet 36, the first pivot arm 58 and the second pivot arm 92 coupled to the axle 66 of the second roller 48 allows the second roller 48 to swing away from the first roller 46. This is due to the force of the dough applied to the pair of rollers, which causes the second roller 48 to be pivoted or displaced. The gap 54 between the first roller 46 and the second roller 48 can then accommodate the dough, while the biasing mechanism 106 biases the second roller 48 towards the first roller 46. That is, the ability to pivot the second roller 48 away from the first roller 46 allows the household food processing device 10 to receive a thicker piece of dough, while the tension provided from at least the biasing mechanism 106 and force from the rotation of the first roller 46 and the second roller 48 flatten the dough as it passes between. After the first roller 46 and the second roller 48 rotate to flatten the inserted dough, and the dough exits the rolling outlet 38. The user may run the dough through the household food processing device 10 multiple times to achieve the desired dough thickness. It is beneficial to gradually decrease the thickness of the dough as to not impact the structural integrity of the dough. After every additional cycle the dough is processed through the household food processing device 10, the thickness of the dough approaches the predetermined thickness set by the user using the dial 80.

In other words, each time the user places the dough in through the household food processing device 10, the first pivot arm 58 and the second pivot arm 92 coupled to the axle 66 of the second roller 48 gradually begin to pivot reducing the gap 54 until it reaches the minimum dough thickness or the first position (FIG. 4). The gradual swing of the first pivot arm 58 and the second pivot arm 92 coupled to the axle 66 of the second roller 48 towards the first position is due to the biasing force applied to the second roller 48 by the biasing mechanism 106.

Once the minimum dough thickness or the first position (FIG. 4) is reached, the first pivot arm 58 and the second pivot arm 92 coupled to the axle 66 of the second roller 48 is stopped from swinging any closer to the first roller 46 by the cam 76. At this point, the dough has been completely processed and the desired dough thickness has been achieved.

Alternatively, the user may manually turn the dial 80 from a larger dough thickness to an intermediate dough thickness, then to a desired dough thickness. This would process the dough in stages, meaning the dough would first be processed to a larger dough thickness, then the user would adjust the dial 80 to an intermediate dough thickness. From there, the user would take the dough with the larger dough thickness and process it to an intermediate dough thickness. Once the intermediate dough thickness is achieved, the user can adjust the dial 80 to the smallest dough thickness, the desired dough thickness. Similarly, the dough can be processed to reach the desired dough thickness.

In the event a foreign object is place into the household food processing device 10 between the first roller 46 and the second roller 48 during operation, the clutch mechanism 110 is configured to disengage or stop the rotation of one of the first roller 46 or the second roller 48. That is, the axle 66 of the second roller 48 is pivoted by the first pivot arm 58 and the second pivot arm 92 towards the predetermined maximum size of the gap 54, or the second position. As the second pivot arm 92 pivots, the distal end 102 comes into contact with the switch 112. Once the axle 66 of the second roller 48 is pivoted to the second position, the distal end 102 pivots or displaces the switch 112 from the un-extended position to the extended position, making the switch 112 no longer flush with the device housing 34. The displacement of the switch 112 compresses the biasing member 114. The biasing member 114 uncouples the pawl 116 from the outer ring 88. The outer ring 88 now uncoupled from the pawl 116 is free to rotate with the planet gears 86. The input gear 84 halts rotation, meaning the mechanical input provided to the planetary gear assembly 82 is no longer provided to the first gear 91 or the second driven gear 93. That is, the rotation of the first roller 46 is stopped or disengaged, and the foreign object can be removed. In another non-limiting example, when a force greater than a predetermined force is applied to at least one of the first roller 46 or the second roller 48, the at least one of the first roller 46 or the second roller 48 the clutch mechanism will be triggered and the at least one of the first roller 46 or the second roller 48 will be disengaged.

Once the foreign object is removed from the household food processing device 10, the user can reset the clutch mechanism 110. That is, the user can flip the switch 112 to be flush with the device housing 34. The biasing member 114 contracts and the pawl 116 re-couples with the outer ring 88. From there, the household food processing device 10 can be operated.

Aspects of the disclosure provide for several benefits. The household food processing device provides a user-friendly mechanism to adjust the desired dough thickness. The user interface allows for an intuitive operation of the thickness adjustment mechanism, where the user is provided with multiple dough thickness selections.

In addition, the clutch mechanism provides an automatic stop function to the household food processing device. In the event a foreign object enters the rolling inlet, the household food processing device will automatically disengage the rollers, allowing the user to remove the foreign object quickly and without turning off the stand mixer.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Moreover, while “a set of” or “a plurality of” various elements have been described, it will be understood that “a set” or “a plurality” can include any number of the respective elements, including only one element. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the following clauses:

A household food processing device, comprising: a housing; a pair of rollers comprising a first roller that is rotatable about a stationary axis and a second roller rotatable about a second axis wherein the pair of rollers define a gap therebetween and a size of the gap defines a dough thickness, and wherein the size of the gap is adjustable by moving the second axis of the second roller; a biasing mechanism having a first end and a second end, wherein the first end of the biasing mechanism couples to a portion of the second roller or a component coupled to the second roller and the second end of the biasing mechanism couples to the housing, and wherein the biasing mechanism biases the second roller towards the first roller; and a clutch mechanism configured to disengage at least one of the first roller or the second roller.

The household food processing device of any preceding clause, further comprising a first pivot arm having a first end and a second end, wherein the first end of the first pivot arm operably couples to the second roller, and the second end of the first pivot arm defines a pivot point about which the first pivot arm and the second roller pivot.

The household food processing device of any preceding clause, wherein the component coupled to the second roller is a second pivot arm, wherein the first end of the biasing mechanism couples to the second pivot arm.

The household food processing device of any preceding clause, wherein the second pivot arm operably couples to the second roller at a receiving portion, wherein the second pivot arm and the second roller rotate about a pivot point spaced from the receiving portion.

The household food processing device of any preceding clause, wherein when a force greater than a predetermined force is applied to at least one of the first roller or the second roller, the clutch mechanism disengages at least one of the first roller or the second roller.

The household food processing device of any preceding clause, further comprising a pinion gear operably coupled to the second roller.

The household food processing device of any preceding clause, wherein the pinion gear is mounted to an axle of the second roller.

The household food processing device of any preceding clause, comprising a second gear and wherein the pinion gear is moveable along a body of the second gear to change the size of the gap.

The household food processing device of any preceding clause, wherein the second gear is a rack gear.

The household food processing device of any preceding clause, further comprising a dial operable by a user and wherein the dial is coupled to a cam for defining a minimum size of the gap.

The household food processing device of any preceding clause, further comprising an indexing mechanism and wherein the first end of the first pivot arm is operably coupled to the indexing mechanism and moveable between a first position defining a gap having a first size and a second position defining a gap having a second size.

The household food processing device of any preceding clause, wherein the indexing mechanism defines a number of intermediate positions having respective intermediate gap sizes.

The household food processing device of any preceding clause, further comprising a user interface configured to provide input to the indexing mechanism.

The household food processing device of any preceding clause, wherein the user interface is a dial configured to provide mechanical input to the indexing mechanism.

The household food processing device of any preceding clause, wherein the biasing mechanism is a spring and the spring provides a biasing force to the second roller such that force within a predetermined range is provided to the second roller regardless of a size of the gap.

The household food processing device of any preceding clause, wherein the clutch mechanism includes a switch, a biasing member, and a pawl, wherein the pawl is selectively coupled to an outer ring of a planetary gear assembly and the switch is coupled to the pawl by the biasing member.

The household food processing device of any preceding clause, wherein a distal end of the second pivot arm is configured to displace the switch and uncouple the pawl from the outer ring at a predetermined maximum size of the gap.

The household food processing device of any preceding clause, wherein the distal end of the second pivot arm extends past the pivot point.

The household food processing device of any preceding clause, wherein the switch is rotatable about a switch pivot point and wherein the switch is configured to be displaced from an un-extended position to an extended position.

The household food processing device of any preceding clause, wherein the household food processing device is adapted to be mounted as an attachment to a stand mixer, the stand mixer having a drive outlet attachment hub.

The household food processing device of any preceding clause, further comprising an input hub configured for attachment with the drive outlet attachment hub and wherein the input hub is configured to support the household food processing device.

The household food processing device of any preceding clause, further comprising an indexing mechanism with a rotatable cam, wherein a position of the cam defines a minimum size of the gap.

The household food processing device of any preceding clause. further comprising a dial operably coupled to the rotatable cam, wherein the dial is configured to rotate the rotatable cam to adjust the minimum size of the gap.

What is claimed is:

1. A household food processing device, comprising:
a housing;
a pair of rollers comprising a first roller that is rotatable about a stationary axis and a second roller rotatable about a second axis wherein the pair of rollers define a gap therebetween and a size of the gap defines a dough thickness, and wherein the size of the gap is adjustable by moving the second axis of the second roller;
a biasing mechanism having a first end and a second end, wherein the first end of the biasing mechanism couples to a portion of the second roller or a component coupled to the second roller and the second end of the biasing mechanism couples to the housing, and wherein the biasing mechanism biases the second roller towards the first roller; and
a clutch mechanism configured to disengage at least one of the first roller or the second roller.

2. The household food processing device of claim 1, further comprising a first pivot arm having a first end and a second end, wherein the first end of the first pivot arm operably couples to the second roller, and the second end of the first pivot arm defines a pivot point about which the first pivot arm and the second roller pivot.

3. The household food processing device of claim 2, wherein the component coupled to the second roller is a second pivot arm, wherein the first end of the biasing mechanism couples to the second pivot arm.

4. The household food processing device of claim 3, wherein the second pivot arm operably couples to the second roller at a receiving portion, wherein the second pivot arm and the second roller rotate about a pivot point spaced from the receiving portion.

5. The household food processing device of claim 1, wherein when a force greater than a predetermined force is applied to at least one of the first roller or the second roller, the clutch mechanism disengages at least one of the first roller or the second roller.

6. The household food processing device of claim 1, further comprising a pinion gear operably coupled to the second roller.

7. The household food processing device of claim 6, wherein the pinion gear is mounted to an axle of the second roller.

8. The household food processing device of claim 6, further comprising a second gear and wherein the pinion gear is moveable along a body of the second gear to change the size of the gap.

9. The household food processing device of claim 8, wherein the second gear is a rack gear.

10. The household food processing device of claim 1, further comprising a dial operable by a user and wherein the dial is coupled to a cam for defining a minimum size of the gap.

11. The household food processing device of claim 1, further comprising an indexing mechanism and wherein the first end of the first pivot arm is operably coupled to the indexing mechanism and moveable between a first position defining a gap having a first size and a second position defining a gap having a second size.

12. The household food processing device of claim 11, further comprising a user interface configured to provide input to the indexing mechanism.

13. The household food processing device of claim 12, wherein the user interface is a dial configured to provide mechanical input to the indexing mechanism.

14. The household food processing device of claim 1, wherein the biasing mechanism is a spring and the spring provides a biasing force to the second roller such that force within a predetermined range is provided to the second roller regardless of a size of the gap.

15. The household food processing device of claim 1, wherein the clutch mechanism includes a switch, a biasing member, and a pawl, wherein the pawl is selectively coupled to an outer ring of a planetary gear assembly and the switch is coupled to the pawl by the biasing member.

16. The household food processing device of claim 15, wherein a distal end of the second pivot arm is configured to displace the switch and uncouple the pawl from the outer ring at a predetermined maximum size of the gap.

17. The household food processing device of claim 16, wherein the switch is rotatable about a switch pivot point and wherein the switch is configured to be displaced from an un-extended position to an extended position.

18. The household food processing device of claim 1, wherein the household food processing device is adapted to be mounted as an attachment to a stand mixer, the stand mixer having a drive outlet attachment hub.

19. The household food processing device of claim 18, further comprising an input hub configured for attachment with the drive outlet attachment hub and wherein the input hub is configured to support the household food processing device.

20. The household food processing device of claim 19, further comprising an indexing mechanism with a rotatable cam, wherein a position of the cam defines a minimum size of the gap.
